(19) United States
(12) Patent Application Publication
(10) Pub. No.: US 2003/0163435 A1
(43) Pub. Date: Aug. 28, 2003

(54) Credit repair services system

(76) Inventor: Bernadino J. Payone, Livonia, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/084,045

(22) Filed: Feb. 22, 2002

(51) Int. Cl. G06F 17/00

(52) U.S. Cl. 705/500

(57) ABSTRACT

A method to allow an exempt organization to retain the services of one or more non-exempt organizations, including network marketing organizations, and pay such non-exempt organization(s) for the sale or performance of such services before all such credit repair services are performed, while maintaining compliance with law.

### FIELD OF THE INVENTION

The present invention relates to credit repair services and, more specifically, to an innovative method of using the services of non-exempt entities in the marketing and provision of such services.

### BACKGROUND OF THE INVENTION

The nation is awash in consumer debt. According to the National Foundation for Credit Counseling, as of October 2001, the average American household carries almost $8,500 in credit card balances. Organizations that provide credit counseling and repair services perform valuable services to consumers such as counseling consumers about the amount of debt they carry, negotiating with creditors on behalf of consumers, consolidating consumer debts, and making sure that consumers' credit files are accurately kept according to the Fair Credit Reporting Act (16 USC § 1681, et. seq.), among other services that help consumers to reestablish their credit ratings and manage their debt responsibly. Unfortunately, recent changes to the law have restricted the means by which some credit repair some organizations may be paid for their services, making it less feasible for them to provide such services, and limiting the availability of services to the remaining organizations that are not restricted under the new law.

In 1996, the United States Congress passed, and the president signed, the Credit Repair Organizations Act (15 USC §§ 1679, et. seq.) (“CROA”). Effective beginning Apr. 1, 1997, CROA amended Title IV of the Consumer Credit Protection Act (15 USC § 1601, et. seq.) to regulate certain practices of credit repair organizations.

Section 404 of CROA (15 USC § 1679c) prohibits certain activities by credit repair organizations. In particular, the statute states that “[n]o credit repair organization may charge or receive any money or other valuable consideration for the performance of any service which the credit repair organization has agreed to perform for any consumer before such service is fully performed.”

CROA defines “credit repair organization” as “any person who uses any instrumentality of interstate commerce or the mails to sell, provide, or perform (or represent that such person can or will sell, provide, or perform) any service, in return for the payment of money or other valuable consideration, for the express or implied purpose of (i) improving any consumer's credit record, credit history, or credit rating; or (ii) providing advice or assistance to any consumer with regard to any activity or service described in clause (i).” CROA provides for civil liability (15 USC § 1679h) and administrative enforcement (15 USC § 1679i) by private parties and by state and federal officials against those who violate its provisions. Several states have enacted legislation that is similar to CROA.

Some organizations are exempt from the provisions of CROA and may collect funds in connection with the performance of credit repair services at any time, including before the credit repair services are fully performed. For example, CROA provides an exception from its effect by excluding from its definition of credit repair organization (and, therefore, CROA's effect): “(i) any nonprofit organization which is exempt from taxation under section 501(c)(3) of the Internal Revenue Code of 1986 . . . or (iii) any depository institution (as that term is defined in section 3 of the Federal Deposit Insurance Act) or any Federal or State credit union (as those terms are defined in section 101 of the Federal Credit Union Act), or any affiliate or subsidiary of such a depository institution or credit union.”

By limiting the activities of non-exempt organizations, CROA and similar state law discourage the supply of credit repair services for a number of reasons.

(1) Non-exempt organizations bear substantial risks and face other barriers in providing credit repair services.

(a) Virtually every business has difficulties with its accounting system, but CROA substantially raises the stakes for non-exempt organizations in the credit repair industry. Even assuming that businesses and governmental bodies can agree as to when credit repair services under a given contract are fully rendered, a simple timing error in billing could potentially raise substantial liability issues under state and federal law.

(b) Such laws make it difficult to have any ongoing element in a credit repair program, such as the availability of counseling or monitoring or other elements of a holistic approach to credit repair. Non-exempt organizations that perform credit repair services are understandably reluctant to provide ongoing services for fear that picking up the telephone to answer a client's question after having received the client's payment might be construed as a continuation of credit repair services for which the client has already paid and potentially expose the non-exempt organization to CROA or other liability.

(a) It is a truism that a dollar received presently is more valuable than a dollar to be received at some future time, because of both the time value of money and the risk of non-payment over time. CROA makes prepayment unavailable to a non-exempt organization, which makes the field less profitable and diminishes the economic incentive to provide these beneficial services.

CROA might have the goal of preventing consumers from paying for services they never receive, but CROA also may effectively prevent consumers from receiving follow-up services they may need and prevent businesses that want to deliver those services from delivering them.

(2) Exempt organizations can and do benefit from the services and products of non-exempt organizations.

(a) Many of the most valuable tools and services for credit repair were developed by, and are owned by, non-exempt organizations.

(b) Non-exempt organizations, especially network marketing organizations, have substantial channels through which credit repair services can be offered to those in need of them. Consumers and commercial enterprises buy and sell a vast array of goods and services in the United States each year using network marketing. Based on the proposition that customers are often the best advocates for the products and services they buy, network marketing offers customers of a product the opportunity to sell the products to others and to build networks of others like them. Firms that sell products and services using network marketing (each a “network marketing organization”) typically recruit independent sales representatives. The independent sales representatives then may (but are not required to) recruit others, who may then (but are not required to) recruit still others. For example, using a basic assumption that each of a firm's independent sales representatives recruits three others, and that each of those recruits three others, the firm can have almost a thousand independent sales representatives by the sixth iteration of the process. Network marketing is a powerful tool that makes use of the personal contacts that almost any potential independent sales representative has simply by virtue of his or her normal social circles. The larger a representative's social circle and the harder the representative is willing to work, the greater the representative's potential to build a successful sales network for the network marketing organization. Network marketing systems are also efficient in that they operate with very little overhead. Each sales representative is an independent operator in a contractual relationship with the network marketing organization. Sales representatives usually operate out of their homes and they manage their own inventory and ordering processes. Sales representatives build networks from circles of existing acquaintances and this, although time-intensive, saves the network marketing organization the substantial expense of identifying potential sales representatives from among populations of strangers.

(3) Exempt organizations are limited in their abilities to refer clients to non-exempt organizations for credit repair services because the risks imposed by CROA and similar law chill non-exempt organizations' willingness to provide such services.

Considering the above, it would be desirable to provide a method for exempt organizations to use the services of non-exempt organizations to further the ends of the exempt organizations, and especially to do so using a network marketing organization.

### SUMMARY OF THE INVENTION

In one aspect, the present invention provides a method whereby an exempt organization may use the services of one or more non-exempt organizations as the exempt organization provides credit repair services. The exempt organization forms a contractual relationship with one or more non-exempt organizations on arm's-length terms and for fair market consideration wherein the non-exempt organization and/or its agents provide goods and/or services to the exempt organization. As part of such contractual relationship, the exempt organization may pay the non-exempt organization and/or its agents for said goods and/or services without regard to whether some or all of the related credit repair services are fully performed. Thus, the exempt organization is able to use the services of non-exempt organizations in a manner that encourages the non-exempt organizations to provide products and services because the non-exempt organizations are assured of compliance with CROA and similar law.

Accordingly, the present invention provides a method of using the services of non-exempt organizations, comprising the steps of providing an exempt entity that will perform credit repair services; identifying or providing a non-exempt organization that sells goods and/or services that may be useful in rendering credit repair services; causing the exempt organization to enter into one or more agreements with such non-exempt organization(s); providing in the agreement that the non-exempt organization and/or its agents will perform services related to credit repair; providing further in the agreement for payment by the exempt organization to the non-exempt organization and/or its agents of fair market consideration at times that are or may be before the credit repair services rendered by the exempt organization are fully performed; causing the non-exempt organization and/or its agents to provide the services related to credit repair to the exempt organization; and causing the exempt organization to pay to the non-exempt organization and/or its agents at times that are or may be before all of the related credit repair services are fully rendered.

The present invention also provides a means by which a network marketing organization fulfils the role of the non-exempt organization.

### BRIEF DESCRIPTION OF THE DRAWING

FIG. 1 is a schematic diagram of services and payment relationships between an exempt organization, a non-exempt organization, a network marketing organization, and a client.

### DETAILED DESCRIPTION OF THE PREFERRED EMBODIMENTS

In order to provide a better understanding of the present invention, the following terms are defined herein, but such definitions shall not limit the ordinary meaning of these terms:

(a) “client” means any consumer, payment for the provision of credit repair services to or for whom, before such services are fully rendered, is prohibited by any law.

(b) “credit repair services” means any services provided or performed for the express or implied purpose of (i) improving any consumer's credit record, credit history, or credit rating; or (ii) providing advice or assistance to any consumer with regard to any activity or service described in clause (i).

(c) “CROA” means the Credit Repair Organizations Act (15 USC §§ 1679, et. seq.).

(d) “downline” means the marketing network of independent representative(s) recruited by a given independent representative, whether directly (by personally recruiting such independent representatives) or indirectly (by having such independent representatives recruit still other independent representatives, and so on in each iteration).

(e) “exempt organization” means an organization that is not prohibited by a restrictive law from charging or receiving any money or other valuable consideration for the performance of any service that the organization has agreed to perform for any consumer before such service is fully performed. The term includes, to the extent exempted from any restrictive law, (i) any nonprofit organization that is exempt from taxation under section 501(c)(3) of the Internal Revenue Code of 1986 or (ii) any depository institution (as that term is defined in section 3 of the Federal Deposit Insurance Act) or any federal or state credit union (as those terms are defined in section 101 of the Federal Credit Union Act), or any affiliate or subsidiary of such a depository institution or credit union.

(f) “includes” means “includes, but is not limited to,” and “including” means “including, but not limited to.”

(g) “network marketing organization” means a system under which an entity and one or more independent representative(s) enter into, and perform under, agreements under which: independent representatives may sell or other wise provide the goods and/or services of the entity to consumers and receive compensation from the entity or another person in the independent representative's upline, sell or otherwise provide goods or services for more than the independent representative paid to the entity and/or another person in the independent representative's upline or receive other compensation for selling or otherwise providing the entity's goods and/or services; and independent representatives may recruit other persons to be independent representatives and be compensated based on the sales or other provision of the firm's goods and/or services by other independent representatives in the independent representative's downline.

(h) “non-exempt organization” means any person that if it sells, provides or performs (or represents that such person can or will sell, provide, or perform) credit repair services, would be prohibited by a restrictive law from charging or receiving any money or other valuable consideration for the performance of any credit repair services that the organization has agreed to perform for any consumer before such service is fully performed.

(i) “person” means an individual, corporation, partnership, limited partnership, limited liability company, trust or other business organization, whether incorporated or otherwise recognized by the law as a separate person or not.

(j) “restrictive law” means any law of any kind, including CROA, that forbids, or provides a civil or criminal action for, or provides for administrative enforcement to prohibit, charging or receiving any money or other valuable consideration for the performance of credit repair services or similar services before such service is fully performed.

(k) “upline” means the marketing network of independent representatives through which a given independent representative was recruited.

Implicit in CROA is the proposition that a non-exempt organization may “charge or receive . . . money or other valuable consideration for the performance of [a] service . . . before such service is fully performed” so long as the non-exempt organization has not “agreed to perform [the service] for any consumer.” An exempt organization may arrange for such a non-exempt organization to provide the credit repair services to the exempt organization instead of to any consumer. It does not matter under CROA when an exempt organization receives payment for credit repair services, so the exempt organization may receive payment before all such services are fully performed and compensate its non-exempt contractors as it sees fit.

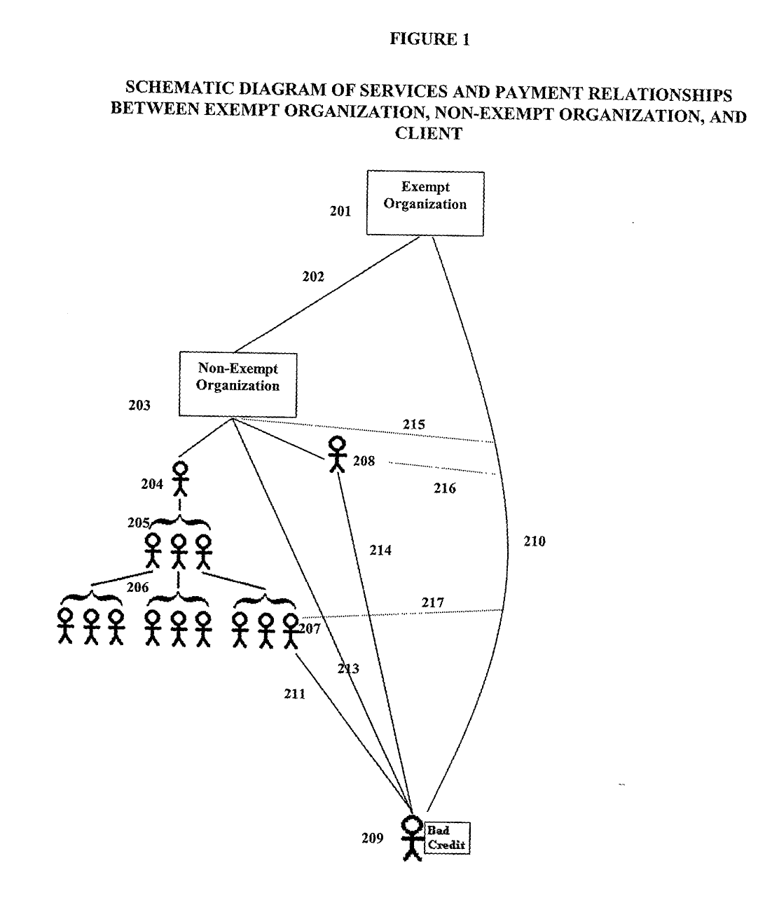

Referring now to FIG. 1, exempt organization 201 enters into a contractual relationship 202 with a non-exempt organization 203. The contractual relationship may be for any services related to credit repair services and that provide value for the exempt organization. Such services might include licenses to use proprietary technology (such as hardware, software, algorithms, techniques, and the like) in the rendering of credit repair services; and/or managerial and administrative functions of the exempt organization, such as making initial client contacts, performing client intake services, and selling to clients contracts for performance of credit repair services by the exempt organization; and/or such backroom operations of the exempt organization as are not prohibited under applicable restrictive laws.

The exempt organization may also enter into agreements 210 with a client 209 under which the exempt organization provides credit repair services to the client and the client pays the exempt organization according to the terms of the agreement 210, whether before, after, or during the time such services are fully rendered. The non-exempt organization 203 and/or its agents may facilitate the formation of this contractual relationship 210 by selling 215, 216, and 217 on behalf of the exempt organization the contracts 210 that entitle the client 209 to credit repair services.

The non-exempt organization 203 may exchange information directly 213 with a client or may integrate independent representatives 204, 207 and 208 into the process.

Independent representatives 204, 207 and 208 of the non-exempt organization 203 may be integrated into such a process by means of a contractual relationship between the non-exempt organization 203 (or with the exempt organization 201 for that matter) and the exchange of information 211 and 214 between clients 209 and the independent representatives 204, 207 and 208. Either the exempt organization 201 or the non-exempt organization 203 may compensate the independent representatives for their services and, in one preferred implementation, the exempt organization 201 directly compensates the independent representatives 204, 207 and 208 and the non-exempt organization 203 guarantees such payment.

Further, the independent representatives may be arranged as a network marketing organization where the products or services sold or delivered are such services as the non-exempt organization 203 may render to the client without violating any restrictive laws. In the example, the non-exempt organization 203 enters into a contractual relationship with an independent representative 204 under which the independent representative 204 performs permissible services for either the client 209 or the exempt organization 201 and may recruit others to do the same. The initial independent representative in the example has directly recruited 205 three additional independent representatives, and each of those three have also recruited 206 three additional representatives. The actual organization may be different, with more or fewer additional independent representatives being recruited at each level.

In the example, an independent representative 207 in the third level provides 211 permitted products and/or services to the client 209 or the exempt organization or assists 217 the client 209 in entering into a contract 210 with the exempt organization 201 for credit repair services. Any independent representative (and not just 207) in the network marketing organization might provide such products and/or services.

In any case, payment for such products and services by the client 209 is made 210 only to the exempt organization 201. Payment to the non-exempt organization 203 or the independent representatives 204, 207 and 208 flows only through the exempt organization 201 and never directly from the client 209.

Using the invention, exempt organizations may procure important services related to credit repair from non-exempt organizations and/or their agents, non-exempt organizations may provide such services without fear of violations of restrictive laws, and non exempt organizations are more likely to make such services available to and through the exempt organization. Using the invention, non-exempt organizations and/or their agents only bill, and receive payment from, an exempt organization, so an error in accounting or timing of collection of payment should no longer result in liability issues. Exempt organizations may use the services of non-exempt organizations to provide the follow-up and ongoing services that are so important to a holistic approach to credit repair and the non-exempt organizations may provide such services without the risk that such follow-up and ongoing services might be construed to extend services beyond the payment date and turn that receipt of payment into a potential violation of a restrictive law. Additionally, the invention makes credit repair services more available to would-be clients.

What is claimed is:

1. A method of using non-exempt organizations in the provision of credit repair services comprising the steps of:
providing an exempt organization that performs, or will perform, credit repair services;
providing a non-exempt organization that has the capacity to deliver goods and/or provide services that are or may be useful in rendering credit repair services;
causing the exempt organization to enter into an agreement with the non-exempt organization;
providing in such agreement that the non-exempt organization shall perform services related to credit repair;
providing further in such agreement for payment by the exempt organization to the non-exempt organization before the credit repair services rendered by the exempt organization are fully performed;
causing the non-exempt organization to provide said services related to credit repair to the exempt organization; and
causing the exempt organization to pay the non-exempt organization under said agreement before all of said related credit repair services are fully rendered.

2. The method of using non-exempt organizations in the provision of credit repair services recited in claim 1 wherein the services related to credit repair is a license to use intellectual property rights.

3. The method of using non-exempt organizations in the provision of credit repair services recited in claim 1 wherein the services related to credit repair include identifying potential clients for credit repair services.

4. The method of using non-exempt organizations in the provision of credit repair services recited in claim 1 wherein said services related to credit repair are assisting clients in entering into contracts with the exempt organization for the provision of credit repair services, or the sale of such contracts to clients on behalf of the exempt organization.

5. The method of using non-exempt organizations in the provision of credit repair services recited in claim 1 wherein the services related to credit repair include managing administrative tasks related to credit repair services, but that do not involve actual provision of credit repair services by the non-exempt organization to clients.

6. The method of using non-exempt organizations in the provision of credit repair services recited in claim 1 wherein the said agreement directs said exempt organization to provide compensation directly to independent representatives of said non-exempt organizations.

7. The method of using non-exempt organizations in the provision of credit repair services recited in claim 1 wherein the non-exempt organization and some or all of its independent representatives are organized into a network marketing organization.
